(19) United States
(12) Patent Application Publication
(10) Pub. No.: US 2025/0279811 A1
(43) Pub. Date: Sep. 4, 2025

(54) Method And Apparatus For Reporting Channel State Information In Mobile Communications

(71) Applicant: MediaTek Inc., Hsinchu City (TW)

(72) Inventors: Chien-Yi Wang, Hsinchu City (TW); Jiann-Ching Guey, Hsinchu City (TW); Yung-Ting Huang, Hsinchu City (TW)

(21) Appl. No.: 18/858,766

(22) PCT Filed: Apr. 21, 2023
(86) PCT No.: PCT/CN2023/089639

§ 371 Date: Oct. 22, 2024

Related U.S. Application Data
(60) Provisional application No. 63/334,320, filed on Apr. 25, 2022.

(51) Int. Cl. H04B 7/06; H04W 72/044

(52) U.S. Cl. CPC H04B 7/0626; H04W 72/044

(57) ABSTRACT

Various solutions for reporting CSI with respect to user equipment and network apparatus in mobile communications are described. An apparatus may determine a set of resource units from a plurality of resource units. The plurality of resource units is time-frequency based. The apparatus may report one or more CSI for the set of resource units to at least one network node of a wireless network.

### CROSS REFERENCE TO RELATED PATENT APPLICATION(S)

The present disclosure is part of U.S. National Stage filing of International Patent Application No. PCT/CN2023/089639, filed 21 Apr. 2023, which claims the priority benefit of U.S. Patent Application 63/334,320, filed 25 Apr. 2022, the content of which herein being incorporated by reference in its entirety.

### TECHNICAL FIELD

The present disclosure is generally related to mobile communications and, more particularly, to channel state information (CSI) reporting with respect to user equipment (UE) and network apparatus in mobile communications.

### BACKGROUND

Unless otherwise indicated herein, approaches described in this section are not prior art to the claims listed below and are not admitted as prior art by inclusion in this section.

Channel State Information Reference Signal (CSI-RS) is a reference signal (RS) that is used in the downlink (DL) direction in 5G NR, for the purpose of channel sounding and used to measure the characteristics of a radio channel. UEs may use these reference signals to measure the quality of the DL channel and report the results in the uplink (UL) through the CSI reports. The UE reports CSI parameters to the network node (e.g., gNB) as feedback. A CSI report includes several parameters, such as CSI-RS Resource Indicator (CRI), Rank Indicator (RI), Layer Indicator (LI), Channel Quality Indicator (CQI), Precoding Matrix Indicator (PMI). The UE uses the CSI-RS to measure the CSI. Upon receiving the CSI parameters, the network node can schedule downlink data transmissions (e.g., modulation scheme, code rate, number of transmission layers and MIMO precoding) accordingly.

In current NR CSI framework, reporting the CSI from the UE to the network node is frequency-based only, which may be less flexible and inefficient. Therefore, there is a need to provide proper schemes to perform CSI reporting more flexibly and more efficiently.

### SUMMARY

The following summary is illustrative only and is not intended to be limiting in any way. That is, the following summary is provided to introduce concepts, highlights, benefits and advantages of the novel and non-obvious techniques described herein. Selected implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to CSI reporting with respect to user equipment and network apparatus in mobile communications.

In one aspect, a method may involve an apparatus determining a set of resource units from a plurality of resource units. The plurality of resource units is time-frequency based. The method may also involve the apparatus reporting one or more CSI for the set of resource units to at least one network node of a wireless network.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising receiving, via the transceiver, a reference signal transmitted by the network side. The processor may also perform operations comprising determining a set of resource units from a plurality of resource units. The plurality of resource units is time-frequency based. The processor may further perform operations comprising reporting, via the transceiver, one or more CSI for the set of resource units to the at least one network node.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting example scenarios under schemes in accordance with implementations of the present disclosure.

FIG. 4 is a diagram depicting an example scenario under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### OVERVIEW

Implementations in accordance with the present disclosure relate to various techniques, methods, schemes and/or solutions pertaining to CSI reporting with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

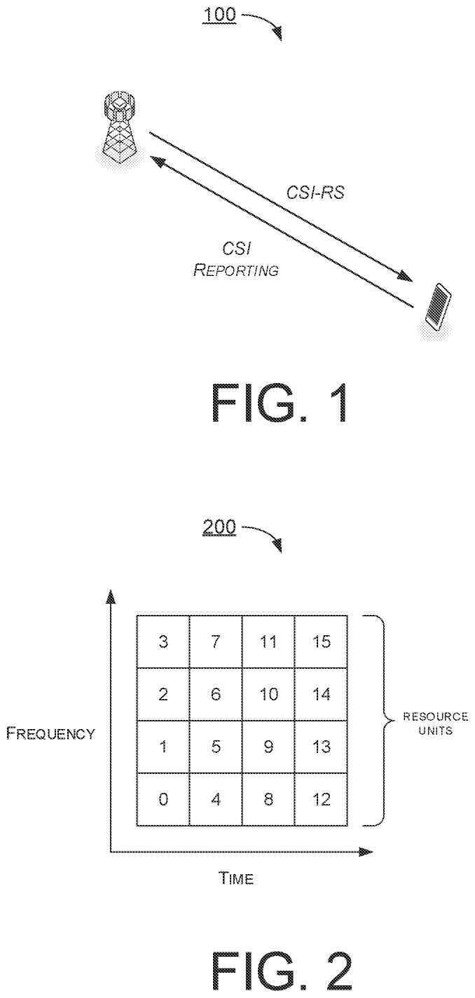

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current NR CSI framework. The UE may connect to the network side. The network side may comprise one or more than one network nodes. The network node may transmit a CSI-RS to the UE. Each UE may acquire CSI between itself and the network node by measuring the CSI-RS and report CSI to the network node.

FIG. 2 illustrates an example scenario 200 under schemes in accordance with implementations of the present disclosure. Scenario 200 involves at least one network node and a UE, which may be a part of a wireless communication network (e.g., an LTE network, a 5G/NR network, an IoT network or a 6G network). Scenario 200 illustrates a plurality of resource units. The UE determines a set of resource units from the plurality of resource units. Each resource unit is time-frequency based. In other words, each resource unit consists of one or more resource blocks (RBs) in frequency domain and one or more slots in time domain. The UE reports one or more CSI for the set of resource units to the at least one network node.

For example, the plurality resource units include sixteen resource units {0, 1, 2, 3, 4, 5, 6, 7, 8, 9, 10, 11, 12, 13, 14, 15}. The UE determines non-contiguous resource units {1, 2, 13, 14} from the sixteen resource units, and reports CSI(s) for resource units {1, 2, 13, 14}.

In some implementations, the at least one network node transmits a bitmap to the UE for the UE to determine the set of resource units according to the bitmap. For example, the plurality resource units include sixteen resource {0, 1, 2, 3, 4, 5, 6, 7, 8, 9, 10, 11, 12, 13, 14, 15}. The at least one network node transmits a 16 bits bitmap [0, 1, 1, 0, 0, 0, 0, 0, 0, 0, 0, 0, 0, 1, 1, 0] corresponding to the sixteen resource units to the UE. After receiving the bitmap, the UE determines to select the resource unit(s) whose corresponding bit(s) in the bitmap is (are) ‘1’, and not to select the resource unit(s) whose corresponding bit(s) in the bitmap is (are) ‘0’. Therefore, according to the bitmap, the UE determines the restricted set of resource units {1, 2, 13, 14} and reports CSI(s) for resource units {1, 2, 13, 14}.

In some implementations, the at least one network node transmits a number to the UE for the UE to determine the set of resource units according to the number. For example, the plurality of resource units include sixteen resource units {0, 1, 2, 3, 4, 5, 6, 7, 8, 9, 10, 11, 12, 13, 14, 15}. The at least one network node transmits a number ‘5’ of resource units to the UE. The UE determines to select five resource units {1, 3, 7, 11, 14} from the resource units and reports CSI(s) for resource units {1, 3, 7, 11, 14}. In other words, the reported set of resource units is determined according to the number of resource unit.

In some implementations, the selected set of resource units is reported from the UE to the at least one network node by using an index. For example, there are sixteen resource units and the at least one network node configures number ‘5’ of resource units to the UE for the UE to select five resource units from sixteen resource units. Therefore, the 5-combinations of the set {0, 1, . . . , 15} consists of

$$( \begin{matrix}16 \\ 5\end{matrix} )$$

possibilities. The at least one network node configures a plurality of indexes (e.g., from ‘0’ to

$$( \begin{matrix}16 \\ 5\end{matrix} ) - {1}^{′} ) ,$$

which corresponds to the

$$( \begin{matrix}16 \\ 5\end{matrix} )$$

possibilities of the set of resource units, to the UE so that the UE reports the index corresponding to the selected set of resource units to the at least one network node.

In some implementations, the at least one network node configures multiple numbers of set of resource units for the UE to utilize. For example, the at least one network node configures numbers ‘3’, ‘4’ and ‘5’ of set of resource units to the UE, and then the UE selects number ‘4’ of set of resource units and determine to select four resource units {1, 7, 11, 14} from the plurality of resource units and reports CSI(s) for resource units {1, 7, 11, 14}.

In some implementations, according to at least one of: (1) a capability of throughput of the UE; and (2) a transmission prediction (e.g., prediction error), the UE determines the set of resource units by itself. The UE transmits a bitmap of the plurality of the resource units to the at least one network node. For example, the plurality of resource units include sixteen resource units {0, 1, 2, 3, 4, 5, 6, 7, 8, 9, 10, 11, 12, 13, 14, 15} and the UE determines the set of resource units {1, 2, 13, 14}. The UE transmits a 16 bits bitmap [0, 1, 1, 0, 0, 0, 0, 0, 0, 0, 0, 0, 0, 1, 1, 0] corresponding to the selected set of resource units {1, 2, 13, 14} to the at least one network node. After receiving the bitmap, the at least one network node is notified of the set of resource units by the resource unit(s) whose corresponding bit(s) in the bitmap is (are) ‘1’. Therefore, according to the bitmap, the at least one network node is notified of the set of resource units {1, 2, 13, 14}.

In some implementations, the plurality of resource units starts from a specific slot, and the specific slot is: (1) an uplink slot of CSI reporting; or (2) a slot after a number of slot after the uplink slot. The number of slot is configured by the at least one network node. For example, the specific slot is slot n+X. Slot n is an uplink slot of CSI reporting. Parameter X is value configured by the at least one network node.

In some implementations, one CSI is reported for one resource unit in the set of resource units (i.e., the CSI and the resource are one-to-one). For example, when the set of resource units includes resource units {0, 1, 2} and the CSIs are CRIs, the UE calculates and reports CRI 0, CRI 1 and CRI 2 for resource unit 0, resource unit 1 and resource unit 2 respectively. When the set of resource units includes resource units {0, 1, 2} and the CSIs are RIs, the UE calculates and reports RI 0, RI 1 and RI 2 for resource unit 0, resource unit 1 and resource unit 2 respectively. When the set of resource units includes resource units {0, 1, 2} and the CSIs are LIs, the UE calculates and reports LI 0, LI 1 and LI 2 for resource unit 0, resource unit 1 and resource unit 2 respectively. When the set of resource units includes resource units {0, 1, 2} and the CSIs are PMIs, the UE calculates and reports PMI 0, PMI 1 and PMI 2 for resource unit 0, resource unit 1 and resource unit 2 respectively. When the set of resource units includes resource units {0, 1, 2} and the CSIs are CQIs, the UE calculates and reports CQI 0, CQI 1 and CQI 2 for resource unit 0, resource unit 1 and resource unit 2 respectively.

In some implementations, one CSI is reported for multiple resource units in the set of resource units (i.e., the CSI and the resource are one-to-multiple). For example, when the set of resource units includes resource units {3, 4, 5} and the CSI is a calculated CRI for all resource units, the UE reports the calculated CRI for resource units 3, 4, 5. When the set of resource units includes resource units {3, 4, 5} and the CSI is a calculated RI for all resource units, the UE reports the calculated RI for resource units 3, 4, 5. When the set of resource units includes resource units {3, 4, 5} and the CSI is a calculated LI for all resource units, the UE reports the calculated LI for resource units 3, 4, 5.

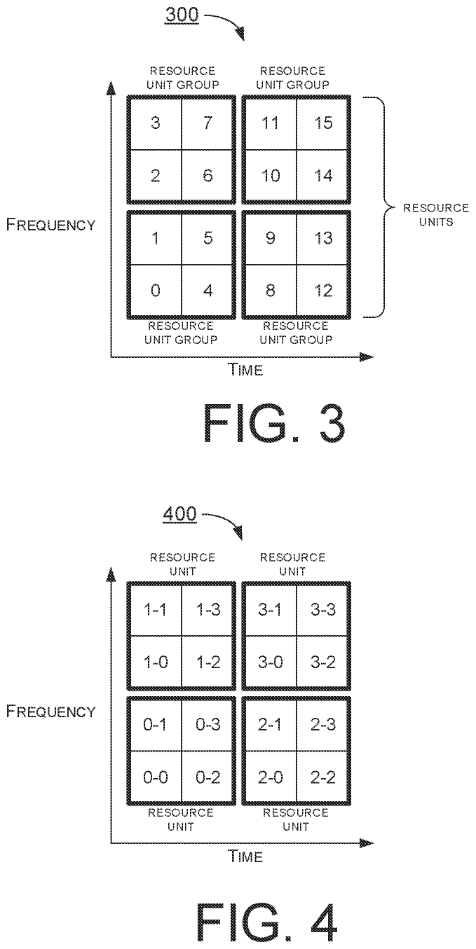

FIG. 3 illustrates an example scenario 300 under schemes in accordance with implementations of the present disclosure. Scenario 300 involves at least one network node and a UE, which may be a part of a wireless communication network (e.g., an LTE network, a 5G/NR network, an IoT network or a 6G network). Scenario 300 illustrates grouping of resource units. A plurality of resource units are divided into a plurality of resource unit groups, and one CSI is reported for resource units in a same resource unit group. For example, sixteen resource units {0, 1, 2, 3, 4, 5, 6, 7, 8, 9, 10, 11, 12, 13, 14, 15} are divided into four resource unit groups {0, 1, 2, 3}, {4, 5, 6, 7}, {8, 9, 10, 11} and {12, 13, 14, 15}. The UE calculates one CSI and reports the calculated CSI for resource units in a same resource unit group.

FIG. 4 illustrates an example scenario 400 under schemes in accordance with implementations of the present disclosure. Scenario 400 involves at least one network node and a UE, which may be a part of a wireless communication network (e.g., an LTE network, a 5G/NR network, an IoT network or a 6G network). Scenario 400 illustrates sub-resource units of resource unit. Each of resource units includes a plurality of sub-resource units. For example, resource unit 0 includes four sub-resource units {0-0, 0-1, 0-2, 0-3}. Resource unit 1 includes four sub-resource units {1-0, 1-1, 1-2, 1-3}. Resource unit 2 includes four sub-resource units {2-0, 2-1, 2-2, 2-3}. Resource unit 3 includes four sub-resource units {3-0, 3-1, 3-2, 3-3}.

In some implementations, one CSI is reported for: (1) one resource unit in the set of resource units; (2) multiple resource units in the set of resource units; or (3) one sub-resource unit of the plurality of sub-resource units. For example, the UE calculates a set of CRI, RI and LI and reports the set of CRI, RI and LI for multiple resource units in a selected set of resource units. The UE calculates one PMI per resource unit in the selected set of resource units and reports PMI(s) per resource unit in the selected set of resource units. The UE calculates one CQI per sub-resource unit of the resource unit(s) in the selected set of resource units and reports CQI(s) per sub-resource unit of the resource unit(s) in the selected set of resource units.

It should be noted that CSI prediction over a certain time may be out of the UE's capability. Therefore, in some implementations, a UE capability should be designed to allow the UE to report its supported maximum time gap from the uplink slot of CSI reporting. In addition, due to limited processing capability, the UE may be able to process or report limited resource units. Therefore, a UE capability should be designed for the UE to report the supported number of resource units to be calculated for a CSI report. Further, a UE capability should be designed for the UE to report the supported number of resource units to be included in a CSI report. The at least one network node may transmit a subset restriction such that certain resource units should not be considered by the UE for CSI reporting. The subset restriction is useful when the at least one network node already allocates certain time-frequency resource units to other UE(s) and does not intend to apply Multiple User-Multiple Input Multiple Output (MU-MIMO).

### Illustrative Implementations

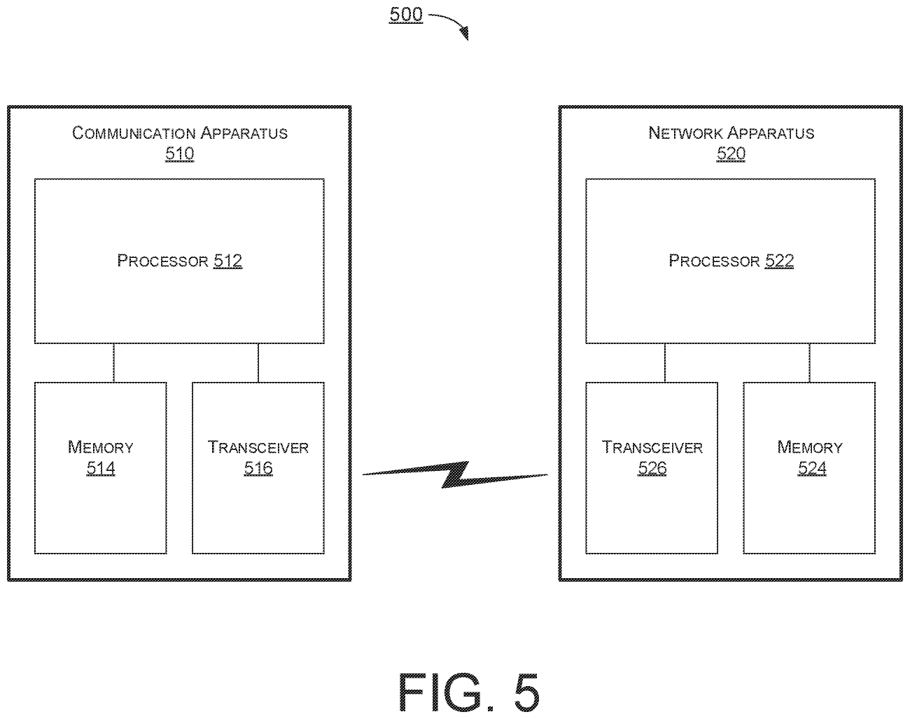

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to CSI reporting with respect to user equipment and network apparatus in mobile communications, including scenarios/schemes described above as well as process 600 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including autonomous reliability enhancements in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

In some implementations, processor 512 may determine a set of resource units from a plurality of resource units. The plurality of resource units is time-frequency based. Processor 512 may report, via transceiver 516, one or more CSI for the set of resource units to network apparatus 520.

In some implementations, each resource unit of the plurality of resource units consist of one or more RBs in frequency domain and one or more slots in time domain.

In some implementations, the set of resource units includes non-contiguous resource units in the plurality of resource units.

In some implementations, processor 512 may receive, via transceiver 516, a bitmap of the plurality of the resource units from network node 520. The set of resource units is determined according to the bitmap.

In some implementations, processor 512 may receive, via transceiver 516, a number of resource units from network node 520. The set of resource units is determined according to the number of resource units.

In some implementations, processor 512 may report, via transceiver 516, an index corresponding to the set of resource units to network node 520. The index corresponds to one combination of the number of resource unit of the plurality of resource units.

In some implementations, the set of resource units is determined according to at least one of a capability of throughput of the apparatus and a transmission prediction.

In some implementations, processor 512 may transmit, via transceiver 516, a bitmap of the plurality of the resource units to network node 520. The bitmap corresponds to the set of resource units.

In some implementations, the plurality of resource units starts from a specific slot. The specific slot is: (1) an uplink slot of CSI reporting; or (2) a slot after a number of slot after the uplink slot. The number of slot is configured by network node 520.

In some implementations, one CSI is reported for one resource unit in the set of resource units or one CSI is reported for multiple resource units in the set of resource units.

In some implementations, the set of resource units includes a plurality of resource unit groups, and one CSI is reported for resource units in a same resource unit group.

In some implementations, each of the set of resource units includes a plurality of sub-resource units, and one CSI is reported for: (1) one resource unit in the set of resource units; (2) multiple resource units in the set of resource units; or (3) one sub-resource unit of the plurality of sub-resource units.

### Illustrative Processes

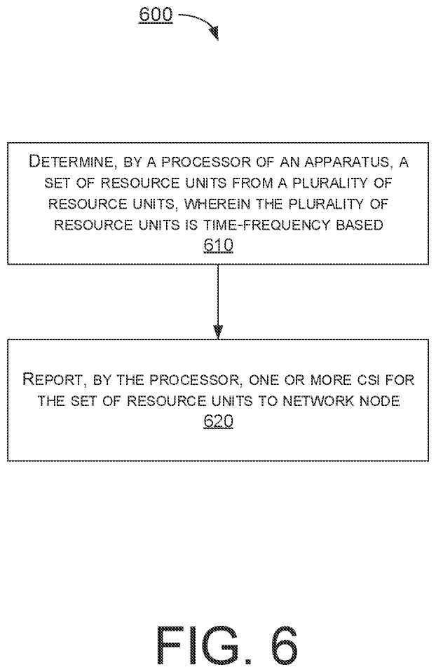

FIG. 6 illustrates an example process 600 in accordance with an implementation of the present disclosure. Process 600 may be an example implementation of above scenarios/schemes, whether partially or completely, with respect to reporting CSI with the present disclosure. Process 600 may represent an aspect of implementation of features of communication apparatus 510. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At 610, process 600 may involve processor 512 of communication apparatus 510 determining a set of resource units from a plurality of resource units. The plurality of resource units is time-frequency based. Process 600 may proceed from 610 to 620.

At 620, process 600 may involve processor 512 reporting one or more CSI for the set of resource units to network node 520.

In some implementations, process 600 may further involve processor 512 receiving a bitmap of the plurality of the resource units from network node 520. The set of resource units is determined according to the bitmap.

In some implementations, process 600 may further involve processor 512 receiving a number of resource units from the at least one network node. The set of resource units is determined according to the number of resource unit.

In some implementations, process 600 may further involve processor 512 reporting an index corresponding to the set of resource units to the at least one network node, wherein the index corresponds to one combination of the number of resource unit of the plurality of resource units.

In some implementations, process 600 may further involve processor 512 transmitting a bitmap of the plurality of the resource units to the at least one network node, wherein the bitmap corresponds to the set of resource units.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a set of resource units from a plurality of resource units, wherein the plurality of resource units is time-frequency based; and
reporting, by the processor, one or more channel state information (CSI) for the set of resource units to at least one network node of a wireless network.

2. The method of claim 1, wherein each resource unit of the plurality of resource units consist of one or more resource blocks (RBs) in frequency domain and one or more slots in time domain.

3. The method of claim 1, wherein the set of resource units includes non-contiguous resource units in the plurality of resource units.

4. The method of claim 1, further comprising:
receiving, by the processor, a bitmap of the plurality of the resource units from the at least one network node;
wherein the set of resource units is determined according to the bitmap.

5. The method of claim 1, further comprising:
receiving, by the processor, a number of resource unit from the at least one network node;
wherein the set of resource units is determined according to the number of resource unit.

6. The method claim 5, further comprising:
reporting, by the processor, an index corresponding to the set of resource units to the at least one network node, wherein the index corresponds to one combination of the number of resource unit of the plurality of resource units.

7. The method of claim 1, wherein the set of resource units is determined according to at least one of a capability of throughput of the apparatus and a transmission prediction.

8. The method of claim 7, further comprising:
transmitting, by the processor, a bitmap of the plurality of the resource units to the at least one network node, wherein the bitmap corresponds to the set of resource units.

9. The method of claim 1, wherein the plurality of resource units starts from a specific slot, the specific slot is an uplink slot of CSI reporting or a slot after a number of slot after the uplink slot, and the number of slot is configured by the at least one network node.

10. The method of claim 1, wherein one CSI is reported for one resource unit in the set of resource units or one CSI is reported for multiple resource units in the set of resource units.

11. The method of claim 1, wherein the plurality of resource units are divided into a plurality of resource unit groups, and one CSI is reported for resource units in a same resource unit group.

12. The method of claim 1, wherein each of the plurality of resource units includes a plurality of sub-resource units, and one CSI is reported for:
one resource unit in the set of resource units;
multiple resource units in the set of resource units; or
one sub-resource unit of the plurality of sub-resource units.

13. An apparatus, comprising:
a transceiver which, during operation, wirelessly communicates with at least one network node of a wireless network; and
a processor communicatively coupled to the transceiver such that, during operation, the processor performs operations comprising:
determining a set of resource units from a plurality of resource units, wherein the plurality of resource units is time-frequency based; and
reporting, via the transceiver, one or more channel state information (CSI) for the set of resource units to the at least one network node.

14. The apparatus of claim 13, wherein each resource unit of the plurality of resource units consist of one or more resource blocks (RBs) in frequency domain and one or more slots in time domain.

15. The apparatus of claim 13, wherein the set of resource units includes non-contiguous resource units in the plurality of resource units.

16. The apparatus of claim 13, wherein, during operation, the processor further performs operations comprising:
receiving, via the transceiver, a bitmap of the plurality of the resource units from the at least one network node;
wherein the set of resource units is determined according to the bitmap.

17. The apparatus of claim 13, wherein, during operation, the processor further performs operations comprising:
receiving, via the transceiver, a number of resource unit from the at least one network node;
wherein the set of resource units is determined according to the number of resource unit.

18. The apparatus of claim 17, wherein, during operation, the processor further performs operations comprising:
reporting, via the transceiver, an index corresponding to the set of resource units to the at least one network node, wherein the index corresponds to one combination of the number of resource unit of the plurality of resource units.

19. The apparatus of claim 13, wherein the set of resource units is determined according to at least one of a capability of throughput of the apparatus and a transmission prediction.

20. The apparatus of claim 19, wherein, during operation, the processor further performs operations comprising:
transmitting, via the transceiver, a bitmap of the plurality of the resource units to the at least one network node, wherein the bitmap corresponds to the set of resource units.
